(19) United States
(12) Patent Application Publication
(10) Pub. No.: US 2013/0284636 A1
(43) Pub. Date: Oct. 31, 2013

(54) PILL CONTAINER WITH REMINDING FUNCTION

(71) Applicants: HONG FU JIN PRECISION INDUSTRY (SHENZHE, Shenzhen (CN); HON HAI PRECISION INDUSTRY CO., LTD., New Taipei (TW)

(72) Inventor: Wen-Hui ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/686,931

(22) Filed: Nov. 28, 2012

(30) Foreign Application Priority Data
Apr. 25, 2012 (CN) 201210123437.5

(51) Int. Cl. A61J 7/04

(52) U.S. Cl. CPC A61J 7/0409
USPC 206/534

(57) ABSTRACT

A pill container includes a container, a reminder unit arranged on the container, a scale arranged in the container to measure a content weight of the content in the container, and a processor electrically coupled to the scale and used to monitor the content weight. When some of the content is removed from the container, the processor determines a decrease in the content weight and determines a dose according to the decrease in the content weight and a weight of a single dosage. If the dose does not match a preset value, the processor controls the reminder unit to output an alert.

### BACKGROUND

1. Technical Field

The present disclosure relates to pill containers, and particularly, to a pill container that can remind users to consume content of the containers on time.

2. Description of Related Art

Many plastic pill containers are designed to be disposable and customarily include a child proof cap. It is not uncommon for people to be on many different medications, which may need to be taken at different times of the day. For example, one medication may be required to be taken twice a day such as in the morning, and again in the evening, whereas another one is to be taken only at bedtime. It may be critical for a person to take their medications as directed, however, because of different dose requirements, it is often difficult for them to remember to do so as directed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a pill container in accordance with an exemplary embodiment.

FIG. 2 is a schematic block diagram of the pill container of FIG. 1.

### DETAILED DESCRIPTION

Embodiments of the present disclosure will be described with reference to the accompanying drawings.

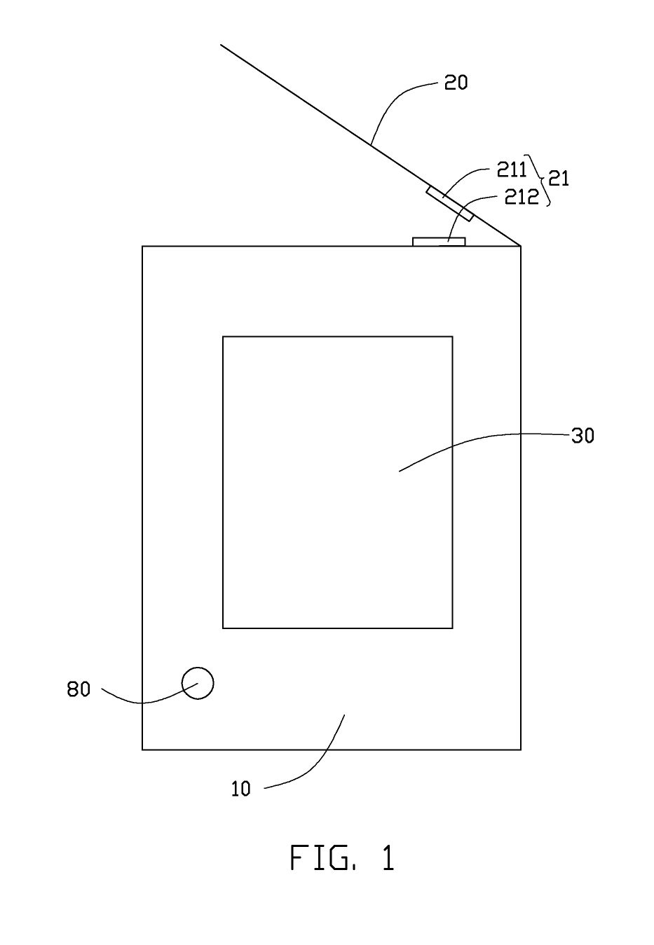

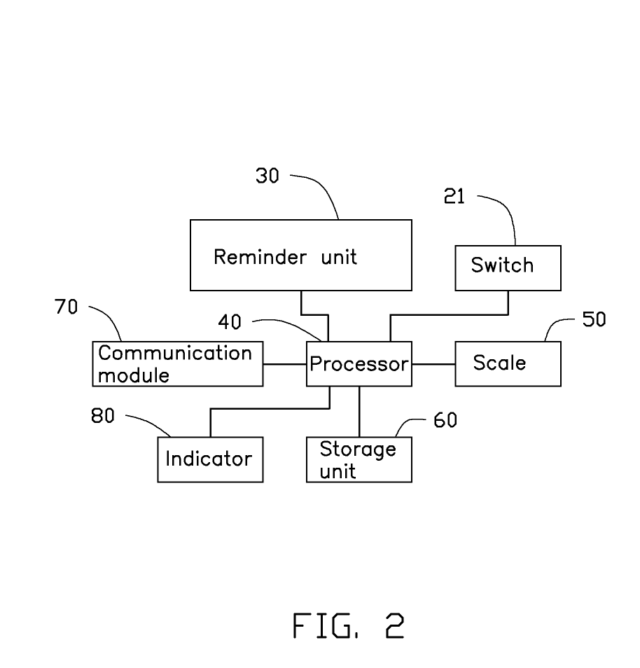

Referring to FIGS. 1 and 2, a pill container 100 includes a container 10 and a cap 20 coupled to the container 10. The container 10 includes an electronic reminder unit 30 (e.g., a display or a speaker) on its lateral surface. The container 10 further includes a processor 40 and a scale 50 located internally. The scale 50 measures the weight of the contents in the container 10. The processor 40 is electrically coupled to the scale 50, and monitors the weight according to signals from the scale 50. When some content is taken out of the container 10, such as pills, the processor 40 receives new weight signals from the scale 50 and calculates a decrease D. The processor 40 then determines a dose according to the decrease D. For example, the processor 40 determines the amount of pills that have been taken out of the container 10 according to the decrease D and the weight S of a single pill. When the amount of content removed, in this case the number of pills, that are taken out of the container 10 does not match a preset value, the processor 40 controls the reminder unit 30 to output an alert to the user. For example, the reminder unit 30 can display a warning message.

The cap 20 is coupled to the rim of the container 10 by a connection member, such as a rubber strip. A switch 21 is arranged between the cap 20 and the rim of the container 10. During opening and closing of the cap 20, the switch 21 changes between an open state and a closed state. For example, the switch 21 includes two contacts 211 and 212 that are respectively arranged on the cap 20 and the rim of the container 10. When the cap 20 is closed, the two contacts 211 and 212 contact each other and a pin of the processor 40 connected to the switch 20 is pulled low. When the cap 20 is opened, the two contacts 211 and 212 disengage from each other, and the pin of the processor 40 connected to the switch 20 is pulled high. The processor 10 can then determine whether the cap 20 is opened or closed according to the state of the pin of the processor 40 connected to the switch 20.

When the cap 20 is opened and the total weight of the content in the container 10 decreases, the processor 40 generates a log file that includes the date and time when the cap 20 is opened, and the decrease D in weight of content of the container 10. The log file is stored in a storage unit 60.

In the embodiment, the pill container 100 further includes a communication module 70, and the reminder unit 30 is a touch sensitive display. The communication module 70 can communicate with a server through a wireless network. A user can send a request for detailed information of the content of the container 100 to the server through the reminder unit 30. The server sends back, if available, the detailed information of the content to the pill container 100. The detailed information may include the weight S of a single pill. The processor 40 stores the detailed information in the storage unit 60.

In the embodiment, the storage unit 60 stores an interface module that can be executed by the processor 40 to provide an interface. The interface allows a user to search for and access the log files stored in the storage unit 60. A user can further set a schedule for consuming content using the interface.

In the embodiment, the pill container 100 further includes an indicator 80. When the processor 40 determines that the weight of the content in the container 10 has not changed when a scheduled time has passed, the processor 40 controls the indicator 80 to flash as an alert to the user.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A pill container comprising:
a container;
a reminder unit arranged on the container;
a scale arranged in the container and configured to measure a content weight of a content accommodated in the container; and
a processor electrically coupled to the scale and configured to monitor the content weight;
wherein when some of the content is removed from the container, the processor determines a decrease in the content weight and determines a dose according to the decrease in the content weight, and if the dose does not match a preset value, the processor controls the reminder unit to output an alert.

2. The pill container according to claim 1, further comprising a cap, a switch and a storage unit, wherein the cap is movably coupled to the container, the switch is arranged between the cap and the container, the switch changes between a closed state and an open stated during opening and closing of the cap, the processor determines whether the cap is opened or closed according to a state of the switch, when the cap is opened and some of the content is removed from the container, the processor generates a log file including the decrease in the content weight and a time when the cap is opened, and stores the log file in the storage unit.

3. The pill container according to claim 2, wherein the switch comprises two contacts that are respectively arranged on the cap and the container.

4. The pill container according to claim 1, wherein the reminder unit is a display.

5. The pill container according to claim 1, wherein the reminder unit is a speaker.

6. The pill container according to claim 1, further comprising an indicator, wherein if the dose does not match a preset value, the processor controls the indicator to flash.
